(19) United States
(12) Patent Application Publication
(10) Pub. No.: US 2016/0269301 A1
(43) Pub. Date: Sep. 15, 2016

(54) DATA TRANSMISSION APPARATUS, DATA PROCESSING SYSTEM, AND DATA PROCESSING METHOD

(71) Applicant: APLIX IP HOLDINGS CORPORATION, Tokyo (JP)

(72) Inventors: Ryu KORIYAMA, Tokyo (JP); Eiji ADACHI, Tokyo (JP); Jangsoo CHUN, Tokyo (JP)

(73) Assignee: APLIX IP HOLDINGS CORPORATION, Tokyo (JP)

(21) Appl. No.: 15/164,742

(22) Filed: May 25, 2016

Related U.S. Application Data
(63) Continuation of application No. PCT/JP2014/080014, filed on Nov. 13, 2014.

(30) Foreign Application Priority Data
Dec. 6, 2013 (JP) 2013-253176

(51) Int. Cl. H04L 12/859; H04L 12/853; H04W 4/00; H04L 12/825

(52) U.S. Cl. CPC H04L 47/2475; H04L 47/25; H04L 47/2416; H04W 4/008

(57) ABSTRACT

The present invention reduces the influence of stuck processing having occurred in an overall data communication system. Data generated by a generation section of a first apparatus is transmitted by a transmission section to a second apparatus at a predetermined transmission rate. A processing section of the second apparatus processes the data received. A processing speed calculation section of the second apparatus calculates a processing speed at which the data is processed in the processing section. A notification section of the second apparatus notifies the first apparatus of the processing speed. A rate setting section of the first apparatus calculates a proper rate for transmitting the data to the second apparatus on the basis of a data processing speed in the second apparatus and performs setup so as to transmit the data to the second apparatus at the proper rate.

### TECHNICAL FIELD

The present invention relates to a data processing system, and more particularly, to a data transmission apparatus that transmits generated data to another apparatus, to a data processing system that includes the apparatus, and to a processing method that is used by the system and the apparatus.

### BACKGROUND ART

In a data communication system that transmits and receives data, there exist factors that delay the data at various points on a data path. A typical factor for delay is, for example, traffic congestion on a communication line. Conventionally known methods are used to reduce the influence of traffic congestion on a communication line. For example, proposed is a system that monitors changes in the signal-to-noise ratio, for example, on an individual packet basis and transmits a data rate adjustment feedback to a transmitting end in order to dynamically adjust a transmission data rate at the transmitting end (refer, for instance, to Patent Literature 1).

### CITATION LIST

### Patent Literature

PTL 1: Japanese Unexamined Patent Application Publication No. 2010-239659

### SUMMARY OF INVENTION

### Technical Problem

The above-mentioned conventional technology focuses attention on the signal-to-noise ratio of a wireless transport channel, that is, the signal-to-noise ratio between a physical layer and a data link layer, and reduces the influence of traffic congestion on a communication line. In recent years, however, smartphones and other similar mobile terminals are in widespread use so that stuck processing considerably occurs in a circuit other than a communication line. Meanwhile, when intermittent communication is established to handle an extremely small amount of data in compliance, for instance, with the Bluetooth (registered trademark) Low Energy standard, it is difficult to grasp the scale of delay in the transmission/reception of data. As described above, when the balance in processing load between communication and a terminal apparatus is different from a conventional one, simple consideration of the signal-to-noise ratio of a communication line is not adequate.

In particular, in a transmission/reception system that requires real-time data transmission, command processing may not be accurately performed in the event of delay so that a result unexpected by a user may be obtained. Let us assume, for example, that a transmission apparatus transmits a signal for a reception apparatus to continuously increase (at a fixed rate) the volume of an audio device attached to the reception apparatus until the transmission of a signal indicative of the next instruction, and that a user of the transmission apparatus, after the transmission of the first signal, operates the transmission apparatus in an attempt to transmit the next signal at a point of time at which a desired volume is obtained. In this instance, an application layer of the reception apparatus processes the next signal with a delay. Therefore, the volume continues to increase for a period equivalent to the delay. Consequently, it is preferred that data to be handled in real time be processed synchronously, that is, processed in such a manner that the transmission rate of a transmitting-end application coincides with the processing rate of a receiving-end application.

The present invention has been made in view of the above circumstances and has an object to reduce the influence of stuck processing encountered in an overall data communication system.

### Solution to Problem

The present invention has been made to solve the above-described problem. According to a first aspect of the present invention, there is provided a data processing system and method. The data processing system includes a first apparatus and a second apparatus. The second apparatus processes data received from the first apparatus. The first apparatus includes a generation section, a transmission section, and a rate setting section. The generation section generates the data. The transmission section transmits the data to the second apparatus at a predetermined transmission rate. The rate setting section calculates a proper rate for transmitting the data to the second apparatus on the basis of a data processing speed in the second apparatus and performs setup so as to transmit the data to the second apparatus at the calculated proper rate. The second apparatus includes a processing section, a processing speed calculation section, and a notification section. The processing section processes the data received from the first apparatus. The processing speed calculation section calculates the speed at which the data is processed in the processing section. The notification section notifies the first apparatus of the calculated processing speed. Consequently, the present invention brings such an effect that the proper rate calculated based on the data processing speed in the second apparatus is set as a generation rate.

According to a second aspect of the present invention, there is provided a data transmission apparatus that transmits generated data to another apparatus. The data transmission apparatus includes a generation section, a transmission section, and a rate setting section. The generation section generates the data. The transmission section transmits the data to the other apparatus at a predetermined transmission rate. The rate setting section calculates a proper rate for transmitting the data to the other apparatus on the basis of a data processing speed in the other apparatus and performs setup so as to transmit the data to the other apparatus at the calculated proper rate. Consequently, the present invention brings such an effect that the proper rate calculated based on the data processing speed in the other apparatus is set as a generation rate.

### Advantageous Effect of Invention

The present invention is capable of achieving an advantageous effect of reducing the influence of stuck processing encountered in an overall data communication system.

### BRIEF DESCRIPTION OF DRAWINGS

[FIG. 1] FIG. 1 is a diagram illustrating an example of a system 90 that is obtained by conceptualizing a data processing system according to an embodiment of the present invention.

FIG. 2] FIG. 2 is a diagram illustrating an exemplary configuration of a transmission apparatus 10 in the data processing system according to the embodiment of the present invention.

[FIG. 3] FIG. 3 is a diagram illustrating an exemplary configuration of a reception apparatus 20 in the data processing system according to the embodiment of the present invention.

[FIG. 4] FIG. 4 is a sequence diagram illustrating an example of a command processing sequence according to the embodiment of the present invention.

[FIG. 5] FIG. 5 is a flowchart illustrating exemplary processing steps for a data processing method according to the embodiment of the present invention.

[FIG. 6] FIG. 6 is a diagram illustrating an exemplary hierarchical configuration of the data processing system according to the embodiment of the present invention.

[FIG. 7] FIG. 7 is a diagram illustrating an exemplary overall configuration of a radio-controlled model car control system contemplated as a concrete example of the data processing system according to the embodiment of the present invention.

### DESCRIPTION OF EMBODIMENT

A mode of embodying the present invention (hereinafter referred to as the embodiment) will now be described.

<Concept>

FIG. 1 is a diagram illustrating an example of a system 90 that is obtained by conceptualizing a data processing system according to the embodiment of the present invention. More specifically, FIG. 1 illustrates an example of a data input/output scheme employed by the system 90. It is assumed that data transmitted from a transmission apparatus include, for example, a command and a response to the command or the like. The response includes a status that indicates the result of command processing.

Upon receipt of a feedback on the notification of a processing speed in a reception apparatus, the transmission apparatus detects an occurrence of certain stuck processing on a path. Here, it is assumed that the path includes all stages between data generation in the transmission apparatus and data processing in the reception apparatus. Based on a final processing speed in the reception apparatus, the transmission apparatus calculates a proper rate (throughput) at which the data is processed without delay (for example, in real time), and applies the calculated proper rate to the transmission of the data to the reception apparatus. Here, the term “transmission” is a broad concept that includes various processes between data generation and data transmission in the transmission apparatus.

The reception apparatus measures (calculates) the processing speed as appropriate. If a change occurs in the processing speed, the reception apparatus notifies the transmission apparatus of the change. For example, there may arise a case where the processing speed is decreased so as to adversely affect command processing. However, a point of time at which a notification is sent to the transmission apparatus is not limited to the time at which the processing speed is decreased. For example, the notification may be sent to the transmission apparatus each time a predetermined time elapses.

The influence exerted by an individual delay or stuck processing in the system 90 on the path is estimated based on the difference between the speed of data input to the system 90 and the speed of data output from the system 90. Thus, the speed of data input to the system 90 is feedback-adjusted. The speed of data input to the system 90 is the rate of command generation and transmission in the transmission apparatus. The speed of data output from the system 90 is the speed of command processing in the reception apparatus. FIG. 1 illustrates an example in which the input speed is X bits (or X bytes or X commands) per millisecond and the output speed is Y bits (or Y bytes or Y commands) per millisecond. The transmission apparatus receives a rate Y indicative of the output speed and uses the received rate Y to adjust a rate X indicative of the input speed.

<Configuration>

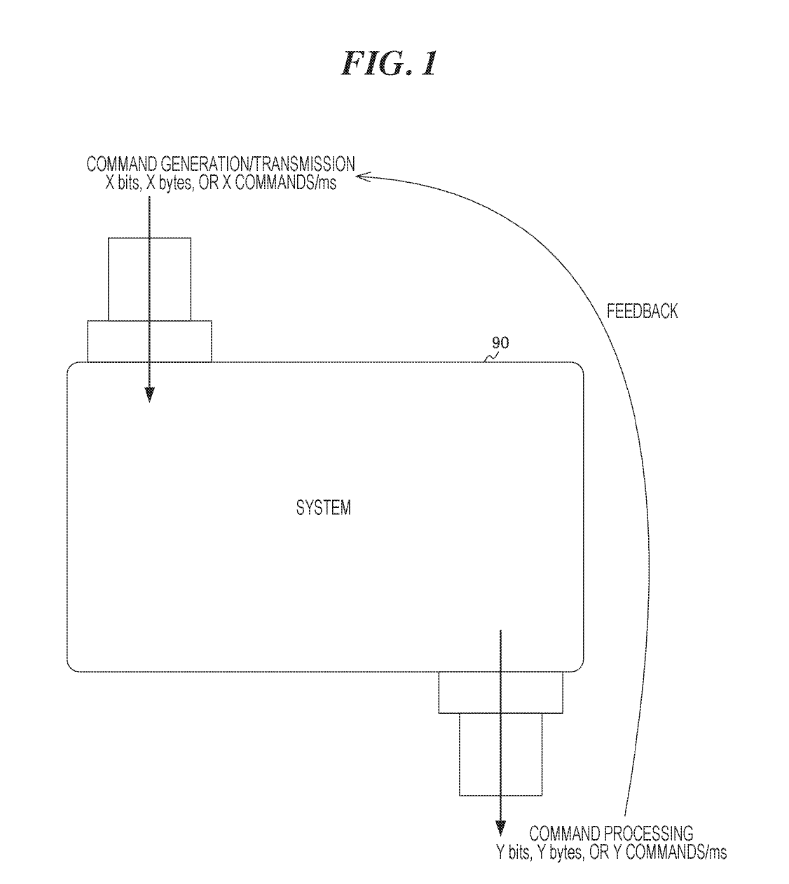

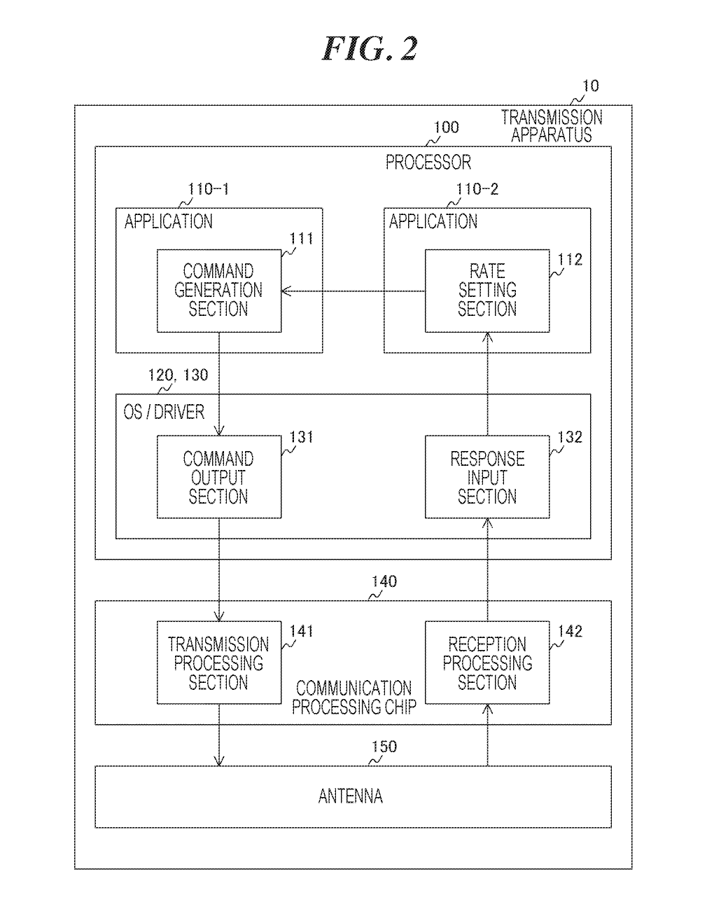

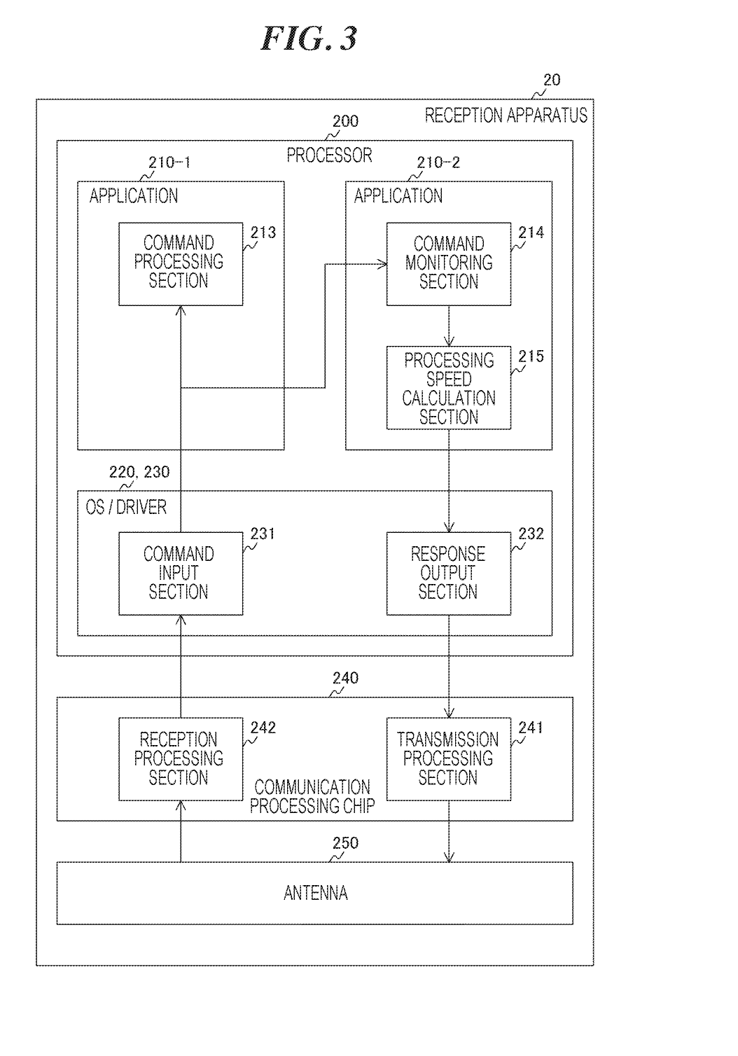

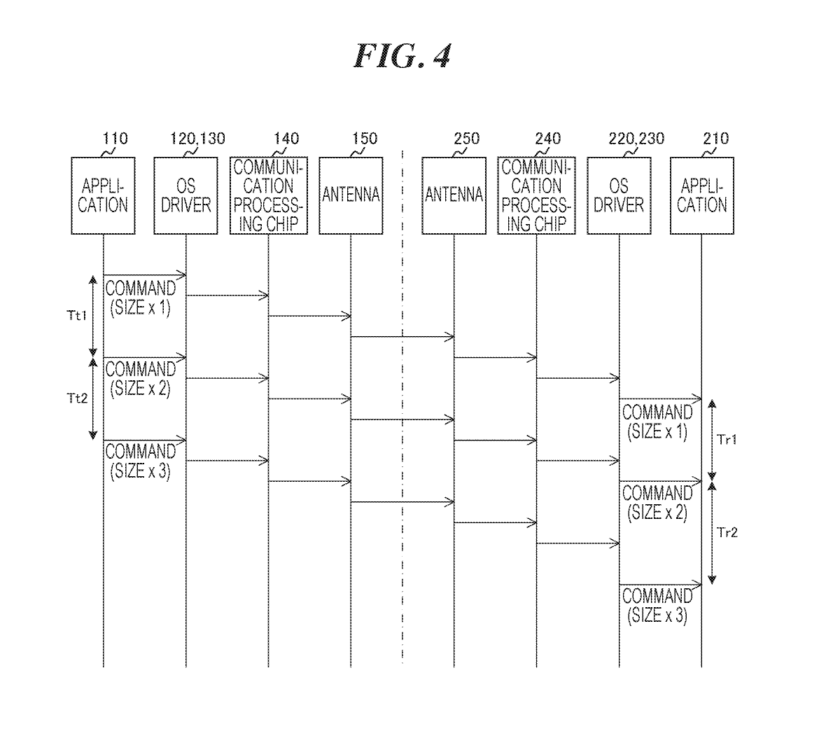

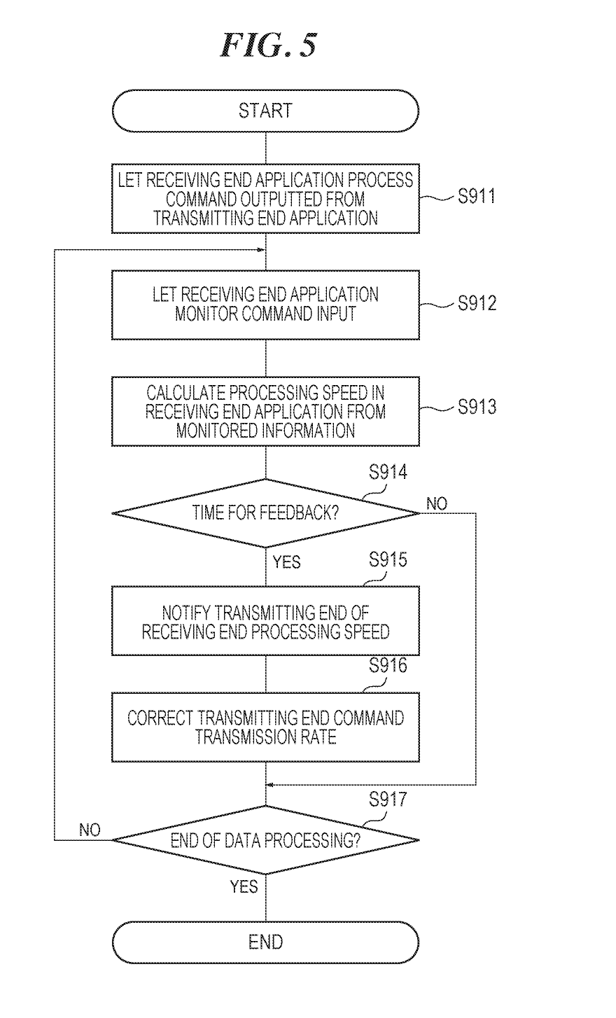

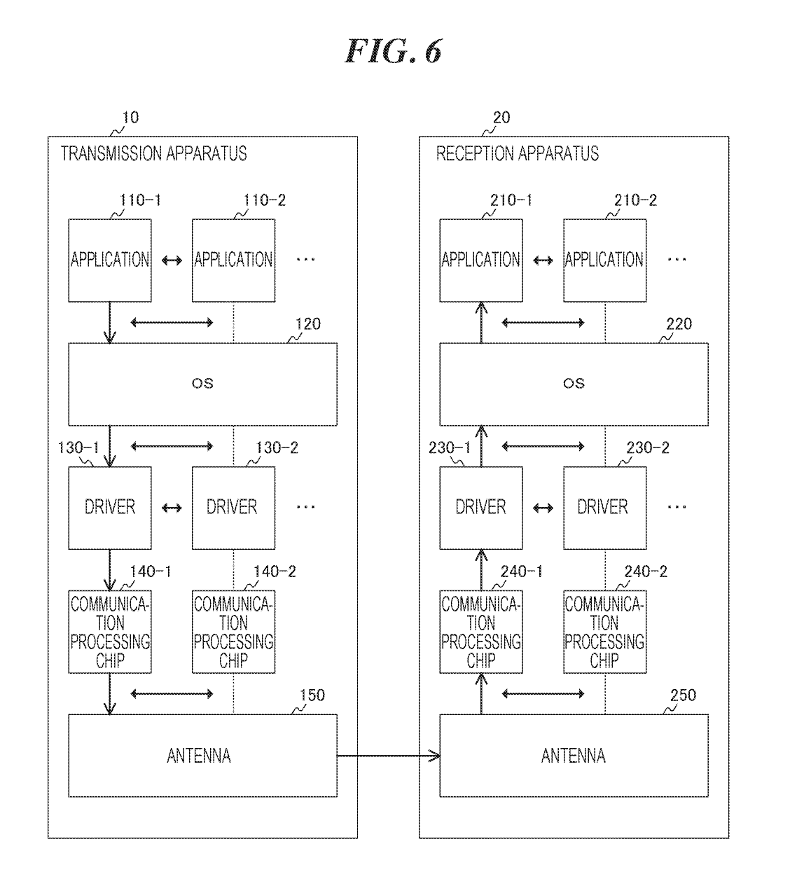

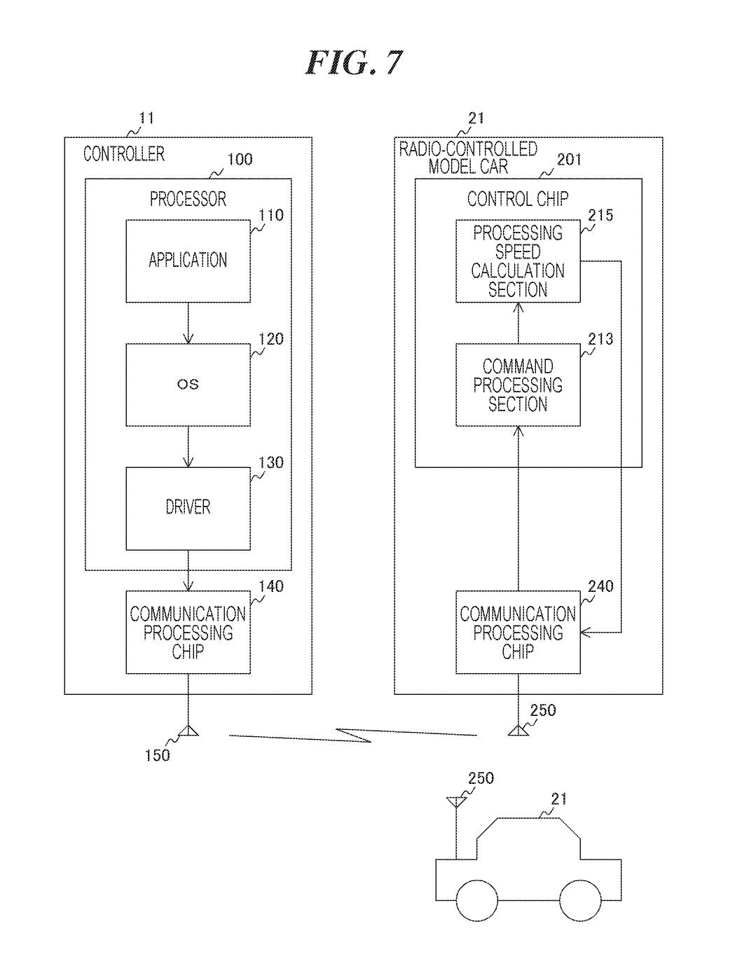

FIG. 2 is a diagram illustrating an exemplary configuration of the transmission apparatus 10 in the data processing system according to the embodiment of the present invention. The transmission apparatus 10 includes a processor 100, a communication processing chip 140, and an antenna 150.

The processor 100 is a processing apparatus that executes software programs. It is assumed that the software programs executed by the processor 100 are applications 110, an operating system (OS) 120, and a driver 130.

The applications 110 are software programs that are disposed close to a user. For example, a plurality of applications 110-1, 110-2 having different functions may exist. Here, such applications are generically referred to as the applications 110. Illustrated in the example of FIG. 2 are the application 110-1 and the application 110-2. The application 110-1 has a function of generating a command that is to be processed in the reception apparatus. The application 110-2 has a function of setting the rate of command generation. The application 110-1 includes a command generation section 111 that generates a command to be processed in the reception apparatus. The application 110-2 includes a rate setting section 112 that sets the rate of command transmission.

The OS 120 is a software program for the data processing system. The driver 130 is a software program that directly operates hardware. Here, the OS 120 and the driver 130 are integrated into a single whole for purposes of illustration. The OS 120 and the driver 130 include a command output section 131 and a response input section 132. The command output section 131 outputs a command generated by the command generation section 111 to the communication processing chip 140. The response input section 132 inputs a response from the communication processing chip 140.

The communication processing chip 140 is a semiconductor chip that performs a process of establishing communication between the processor 100 and an external apparatus. The communication processing chip 140 includes a transmission processing section 141 and a reception processing section 142. The transmission processing section 141 performs a process of transmitting to the external apparatus. The reception processing section 142 performs a process of receiving from the external apparatus. It is assumed that communication standards handled by the communication processing chip 140 are, for example, Bluetooth (registered trademark), Bluetooth (registered trademark) Low Energy, and WiFi (registered trademark) or the like. The embodiment of the present invention achieves a remarkable advantageous effect particularly when intermittent communication is established at predetermined intervals in compliance, for instance, with the Bluetooth (registered trademark) Low Energy or WiFi (registered trademark) standard or the like. The communication processing chip 140 forms a part of a communication layer defined in the appended claims and functions especially as a logic layer.

The antenna 150 is an antenna device that transmits and receives radio waves in order to communicate with the external apparatus. The antenna 150 is connected to the transmission processing section 141 and reception processing section 142 of the communication processing chip 140. The antenna 150 forms a part of a communication layer defined in the appended claims and functions especially as a physical layer.

FIG. 3 is a diagram illustrating an exemplary configuration of the reception apparatus 20 in the data processing system according to the embodiment of the present invention. The reception apparatus 20 includes a processor 200, a communication processing chip 240, and an antenna 250.

The processor 200 is a processing apparatus that executes software programs, as is the case with the processor 100. It is assumed that the software programs executed by the processor 200 are applications 210, an OS 220, and a driver 230, as is the case with the processor 100.

The applications 210 are software programs that are disposed close to the user. A plurality of applications having different functions are generically referred to as the applications 210. Illustrated in the example of FIG. 3 are the application 210-1 and the application 210-2. The application 210-1 has a function of processing a command that is transmitted from the transmission apparatus 10. The application 210-2 has a function of calculating an application processing speed from a command inputted to the application 210-1. The application 210-1 includes a command processing section 213 that processes a command transmitted from the transmission apparatus 10. The application 210-2 includes a command monitoring section 214 and a processing speed calculation section 215. The command monitoring section 214 monitors a command that is inputted to the application 210-1. The processing speed calculation section 215 calculates the application processing speed from time intervals between monitored commands and the amount of data inputted per unit time.

The OS 220 is a software program for the data processing system, as is the case with the OS 120. The driver 230 is a software program that directly operates hardware, as is the case with the driver 130. Here, the OS 220 and the driver 230 are integrated into a single whole for purposes of illustration. The OS 220 and the driver 230 include a command input section 231 and a response output section 232. The command input section 231 inputs a command, which is received from the transmission apparatus 10, through the communication processing chip 240. The response output section 232 outputs a response generated by the application 210-2 to the communication processing chip 240.

The communication processing chip 240 is a semiconductor chip that performs a process of establishing communication between the processor 200 and the external apparatus, as is the case with the communication processing chip 140. The communication processing chip 240 includes a transmission processing section 241 and a reception processing section 242. The transmission processing section 241 performs a process of transmitting to the external apparatus. The reception processing section 242 performs a process of receiving from the external apparatus. The communication processing chip 240 forms a part of a communication layer defined in the appended claims and functions especially as a logic layer.

The antenna 250 is an antenna device that transmits and receives radio waves in order to communicate with the external apparatus, as is the case with the antenna 150. The antenna 250 is connected to the transmission processing section 241 and reception processing section 242 of the communication processing chip 240. The antenna 250 forms a part of a communication layer defined in the appended claims and functions especially as a physical layer.

In the above-described configuration, the processing speed calculation section 215 calculates the application processing speed on the basis of time intervals at which commands (data) monitored by the command monitoring section 214 are inputted and of the size of the commands during the time intervals (the amount of data, the number of commands, the number of packets, etc.) . The calculated application processing speed is then fed back to the transmission apparatus 10.

FIG. 4 is a sequence diagram illustrating an example of a command processing sequence according to the embodiment of the present invention. FIG. 4 illustrates a sequence in which three commands are processed. The three commands are X1, X2, and X3 in data size.

The three commands generated by the application 110 in the transmission apparatus 10 are outputted to the reception apparatus 20. However, at the stage of the application 110, the time intervals between the three commands are Tt1 and Tt2. Subsequently, the commands are transmitted to the reception apparatus 20 through the OS 120, the driver 130, the communication processing chip 140, and the antenna 150, and in the reception apparatus, the commands are inputted to the application 210 through the antenna 250, the communication processing chip 240, the driver 230, and the OS 220. At the stage of the application 210, the time intervals between the three commands are Tr1 and Tr2.

If a delay occurs on a path through which a command is passed from the application 110 to the application 210, the time intervals Tt1 and Tr1, or the time intervals Tt2 and Tr2 do not always coincide with each other. If, for instance, the processing speed calculation section 215 calculates the application processing speed and finds a change in the application processing speed, the transmission apparatus 10 is notified of such a change. This enables the transmission apparatus 10 to output commands at a proper rate.

<Operations>

FIG. 5 is a flowchart illustrating exemplary processing steps for a data processing method according to the embodiment of the present invention.

A command outputted from the application 110-1 of the transmission apparatus 10 is passed along a path of the data processing system and processed by the application 210-1 of the reception apparatus 20 (step S911). In the reception apparatus 20, the command inputted to the application 210-1 is monitored by the application 210-2 (step S912). Next, based on the monitored information, the processing speed in the application 210-1 of the reception apparatus 20 is calculated (step S913).

When a predetermined time comes (when the query in step

S914 is answered “YES”), steps S915 and S916 are performed to achieve feedback from the reception apparatus 20 to the transmission apparatus 10. It is assumed that the predetermined time comes when, for instance, the processing speed is changed or a predetermined period of time has elapsed.

When the feedback is to be achieved, the application 210-2 of the reception apparatus 20 notifies the transmission apparatus 10 of the processing speed calculated in step S913 (step S915). The application 110-2 of the transmission apparatus 10 then sets (corrects) a command transmission rate on the basis of the calculated new processing speed (step S916).

Steps S912 and beyond are repeated until the end of data processing (step S917).

As described above, the influence of stuck processing on a path between data generation and transmission by the transmission apparatus 10 and final data processing in the reception apparatus 20 can be estimated based on a data flow rate at a data entry and at a data exit of the system 90. This makes it possible to grasp a transmission data rate between the transmission apparatus and the reception apparatus and set the transmission data rate accordingly. Consequently, even when data is stuck on a transmission path, smooth data processing can be performed.

FIG. 6 is a diagram illustrating an exemplary hierarchical configuration of the data processing system according to the embodiment of the present invention.

A command (data) outputted from the application 110-1 of the transmission apparatus 10 is passed through the OS 120, the driver 130-1, the communication processing chip 140-1, and the antenna 150 and transmitted from the transmission apparatus 10.

In the reception apparatus 20, the command is passed through the antenna 250, the communication processing chip 240-1, the driver 230-1, and the OS 220 and inputted to the application 210-1.

When a command (data) is to be outputted from the application 110-1 to the application 210-1 for processing purposes, resources available to a data path employed for such a command output are limited because some resources are used, for instance, by another application, the communication processing chip, or the driver. Consequently, data processing is delayed during the use of a logical protocol and the use of a physical protocol.

It is conceivable that the above delay is caused by the following factors. Firstly, the delay may be caused by operations of applications. When a plurality of applications operate, processing resources available to a processor are dispersed. The processing resources available to the processor are partly preoccupied simply due to the operation of another application than the application whose operation is watched.

Secondly, the delay may be caused by the operation of an OS. As applications individually make an OS call, processing performed by the OS is time-multiplexed. When a process is performed to make an OS call in order, for instance, to transmit a command, the processing resources available to the processor are dispersed to decrease a processing rate.

Thirdly, the delay may be caused by a driver operation. When a plurality of drivers operate, the processing resources available to the processor are dispersed to decrease the processing rate.

Fourthly, the delay may be caused by communication processing. As a plurality of chips individually use an antenna, communication is time-multiplexed. When, for example, a smartphone or other multifunctional communication terminal is used to establish Bluetooth (registered trademark) short-range communication and WiFi (registered trademark) wireless LAN communication, the same antenna maybe shared because frequency bands used by Bluetooth (registered trademark) communication and WiFi (registered trademark) communication are close to each other. In a situation where the same antenna is shared, contention occurs if a target application establishes Bluetooth (registered trademark) communication while an irrelevant chip is using a WiFi (registered trademark) communication function.

Fifthly, the delay may be caused by a communication circuit condition. If, for example, circuit condition degradation, packet retransmission, or temporary halt of packet transmission by a pause frame occurs when data is transmitted from the transmission apparatus 10 to the reception apparatus 20, processing may become stuck due to decreased throughput.

The present embodiment adjusts a transmission rate not only by exercising flow control based, for instance, on circuit conditions in order to provide against data transmission delay and data congestion but also by feeding back the occurrence of retransmission and a final processing speed including stuck processing caused by intermediate processing in an apparatus. Thus, the larger the number of processing hierarchical levels and relay points between a transmitting end application and a receiving end application, the more remarkable the advantageous effect.

<Concrete Example>

FIG. 7 is a diagram illustrating an exemplary overall configuration of a radio-controlled model car control system contemplated as a concrete example of the data processing system according to the embodiment of the present invention. It is assumed that the radio-controlled model car control system uses a smartphone or other multifunctional communication terminal as a controller 11 for a radio-controlled model car 21.

The controller 11 has the same internal configuration as the transmission apparatus 10 and includes the processor 100 and the communication processing chip 140. The processor 100 executes a software program having three hierarchical levels, namely, the application 110, the OS 120, and the driver 130.

The radio-controlled model car 21 corresponds to the reception apparatus 20 and includes a control chip 201 and the communication processing chip 240. The control chip 201 corresponds to the processor 200. Here, the control chip 201 includes the command processing section 213 and the processing speed calculation section 215. As the communication processing chip 240, for example, a Bluetooth (registered trademark) transmission/reception IC chip is used.

The command processing section 213 receives a command through the communication processing chip 240 and operates the radio-controlled model car 21 in compliance with the received command. The processing speed calculation section 215 measures or calculates the processing rate of the command processing section 213 from a processing speed achieved by the command processing section 213.

Here, in the controller 11, a delay is caused by the following factors. Firstly, the delay may be caused by an operation of the OS. If, for example, the OS 120 is in a busy state as it is performing a process of UI (user interface) or other process when the OS 120 is about to output a command generated by the application 110 of the controller 11, a command output from the OS 120 is deferred.

Secondly, the delay may be caused by an operation of the driver 130. As one driver 130, a Bluetooth (registered trademark) protocol stack is in charge of a hierarchical level for network communication and, for example, packetizes commands and issues a transmission instruction to the communication processing chip 140. If the communication processing chip 140 is in a busy or other state in which transmission processing is delayed, a command output from the driver 130 is deferred.

Thirdly, the delay may be caused by communication processing. The communication processing chip 140 transmits a command to the radio-controlled model car 21 through the antenna 150. If, for example, the antenna 150 is shared by another communication method or retransmission is repeated a number of time due to excessive noise, a command transmission from the communication processing chip 140 is delayed.

If no feedback is performed on the command transmission rate when the above-described processing delay is encountered, a user's operating command, which is generated at a relatively high speed, is delayed on a path before being conveyed to the radio-controlled model car 21. Thus, an unexpected time lag occurs between command generation and command processing. The present embodiment mitigates such an influence by causing the radio-controlled model car 21 to feed a processing rate back to the controller 11 at a predetermined point of time (for example, at optional intervals or at a time of response to an inquiry from the controller) . The rate of command transmission to the radio-controlled model car 21 is then properly adjusted.

The foregoing embodiment is an exemplary embodiment of the present invention. Matters in the embodiment correlate to invention-defining matters in the appended claims. Similarly, the invention-defining matters in the appended claims correlate to the matters in the embodiment that are named the same as the invention-defining matters. However, it is to be understood that the present invention is not limited to the foregoing embodiment. The present invention can be variously embodied by modifying the foregoing embodiment without departing from the spirit of the present invention.

Further, the processing steps described in conjunction with the foregoing embodiment may be considered as a method including such a series of steps, as a program for causing a computer to execute such a series of steps, or as a recording medium storing the program. As the recording medium, for example, a CD (Compact Disc), an MD (MiniDisc), a DVD (Digital Versatile Disc), a memory card, or Blu-ray (registered trademark) Disc may be used.

### REFERENCE SIGNS LIST

10 . . . Transmission apparatus,

11 . . . Controller,

20 . . . Reception apparatus,

21 . . . Radio-controlled model car,

90 . . . System,

100 . . . Processor,

110 . . . Application,

111 . . . Command generation section,

112 . . . Rate setting section,

130 . . . Driver,

131 . . . Command output section,

132 . . . Response input section,

140 . . . Communication processing chip,

141 . . . Transmission processing section,

142 . . . Reception processing section,

150 . . . Antenna,

200 . . . Processor,

201 . . . Control chip,

210 . . . Application,

213 . . . Command processing section,

214 . . . Command monitoring section,

215 . . . Processing speed calculation section,

230 . . . Driver,

231 . . . Command input section,

232 . . . Response output section,

240 . . . Communication processing chip,

241 . . . Transmission processing section,

242 . . . Reception processing section,

250 . . . Antenna.

1. A data processing system comprising:
a first apparatus; and
a second apparatus that processes data received from the first apparatus;
wherein the first apparatus includes
a first processor that executes a first application for generating the data including a command to be processed in the second apparatus,
a first communication layer that transmits the data generated by the first application to the second apparatus at a predetermined transmission rate, and
a rate setting section that calculates a proper rate for transmitting the data to the second apparatus on the basis of a data processing speed in the second apparatus and performs setup so as to transmit the data to the second apparatus at the proper rate; and
wherein the second apparatus includes
a second processor that executes a second application for processing the command included in the data received,
a processing speed calculation section that calculates the data processing speed in the second processor,
a second communication layer that receives the data transmitted from the first apparatus and inputs the received data to the second application, and
a notification section that notifies the first apparatus of the calculated processing speed.

2. (canceled)

3. The data processing system according to claim 1,
wherein the processing speed calculation section calculates the processing speed from the amount of data inputted to the second application at predetermined unit time intervals.

4. The data processing system according to claim 1,
wherein the rate setting section determines, based on the proper rate, a generation rate at which data is generated by the first application and performs setup so as to generate the data at the determined generation rate.

5. The data processing system according to claim 1,
wherein the proper rate ensures that a delay in the data processing speed in the processing section from a data generation speed in the generation section is at least within a predetermined range.

6. The data processing system according to claim 1,
wherein the notification section notifies the first apparatus of the processing speed that is obtained when the variation of the processing speed calculated by the processing speed calculation section from the last calculated processing speed is greater than a predetermined threshold value.

7. The data processing system according to claim 1,
wherein the first and second communication layers provide intermittent communication at predetermined intervals.

8. The data processing system according to claim 7,
wherein the first and second communication layers are compliant with the Bluetooth Low Energy standard.

9. A data processing method used in a data processing system including a first apparatus that includes a first processor and a first communication layer, and a second apparatus that includes a second processor and a second communication layer and processes data received from the first apparatus, comprising:
a generation step that is performed by the first apparatus to execute a first application in the first processor and generate the data including a command to be processed in the second apparatus;
a transmission step that is performed by the first apparatus to transmit the data to the second apparatus through the first communication layer at a predetermined transmission rate;
a processing step that is performed by the second apparatus to execute a second application in the first processor and process the command included in the data received through the second communication layer;
a processing speed calculation step that is performed by the second apparatus to calculate a processing speed at which the data is processed in the processing step;
a notification step that is performed by the second apparatus to notify the first apparatus of the processing speed; and
a rate setting step that is performed by the first apparatus to calculate a proper rate for transmitting the data to the second apparatus on the basis of the processing speed notified in the notification step and perform setup so as to transmit the data to the second apparatus at the proper rate.

10. A data transmission apparatus comprising:
a first processor that executes a first application for generating the data including a command to be processed in the other apparatus;
a first communication layer that transmits the data generated by the first application to the other apparatus at a predetermined transmission rate; and
a rate setting section that calculates a proper rate for transmitting the data to the other apparatus on the basis of a data processing speed in the other apparatus and performs setup so as to transmit the data to the other apparatus at the proper rate.
